(19) United States
(12) Patent Application Publication
(10) Pub. No.: US 2023/0166989 A1
(43) Pub. Date: Jun. 1, 2023

(54) SYSTEM AND METHOD FOR SEPARATING WATER FROM OIL

(71) Applicant: GIFTEDNESS AND CREATIVITY COMPANY, Safat (KW)

(72) Inventors: YAQOUB ALIBRAHIM, SAFAT (KW); ABDULAZIZ ALSHATTI, SAFAT (KW); HANAN ABDULLAH, SAFAT (KW); ABDULLAH ALMERAJ, SAFAT (KW); ABDULLAH HAMADAH, SAFAT (KW)

(21) Appl. No.: 17/535,855

(22) Filed: Nov. 26, 2021

(51) Int. Cl. C02F 1/48; B03C 1/01; C02F 1/40

(52) U.S. Cl. CPC C02F 1/48; B03C 1/01; C02F 1/40; B03C 2201/18; B82Y 25/00

(57) ABSTRACT

A method of separating water from oil includes combining the oil with a magnetite powder to form a mixture and directing the mixture to a closed chamber having a plurality of magnetic field generating elements. The magnetic field generating elements generate a magnetic field sufficient to separate the magnetite powder and oil from water in the mixture, such that the water sinks to the bottom of the chamber. A valve at a lower end of the chamber can be opened to release the water collected at the bottom of the chamber. The method can be used to enhance the quality of crude oil by lowering the Bs &W content in the crude oil.

### BACKGROUND

### 1. Field

The disclosure of the present patent application relates to separating water from oil or other viscous fluids and, more particularly, to a method and system for liquid separation using magnetite.

### 2. Description of the Related Art

Export standards for exporting crude oil and transferring crude oil to refineries and vessels requires low water and sediment (Bs&W) content in crude oil. Separating oil and other viscous fluids from water is of extreme importance, both economically and environmentally. The amount of Bs&W percentage in crude oil is directly proportional to salt content. The higher the amount of Bs&W, the lower the quality of the crude oil and the higher risk of corrosion to facility and pipelines.

Conventional methods to purify crude oil predominately involve chemicals.

Chemical methods to purify crude oil are associated with high cost and damage to the environment. Chemicals commonly used include stabilizers which adjust the color, pH, corrosion, and enhance the stability of hard water. Solvents minimize the viscosity of the surfactants, depress the freezing point of the dispersant, dilute the dispersant compound and maximize the dispersant concentrations. Surfactants minimize the formation of oil in the water emulsion, to increase and spread the microbial decomposition surface area.

Thus, a method and system for separating oil from water solving the aforementioned problems is desired.

### SUMMARY

A method for separating water from oil can include the steps of adding magnetite powder to a mixture of oil and water and subjecting the resulting mixture to a magnetic field, such that the magnetite powder and the oil are drawn out of the mixture.

A system for separating oil from water includes a closed chamber with an inlet pipe, a crude oil outlet pipe and a water outlet pipe extending into the chamber. The inlet pipe and the crude oil outlet pipe are at a higher level in the chamber than the water outlet pipe. The magnetite powder, oil, and water can be fed into the chamber via the inlet pipe. The magnetite powder combines with or binds to the oil in the mixture. A plurality of magnetic field generating elements extend into the chamber and generate a magnetic field when activated. The magnetic field generating elements can separate the oil and magnetite powder combination from the water by raising the oil and magnetite powder combination such that the water sinks to the bottom of the chamber. The water can be removed via the water outlet pipe. A lower valve of the chamber can be opened to drain the water until the crude oil and magnetite powder combination is lowered to a predetermined level, at which point the valve can be closed. A sensor at a lower portion of the chamber can be configured to detect crude oil proximate to the valve. In an embodiment, the chamber cavity can provide a magnetic field of about 12,000 gauss.

These and other features of the present subject matter will become readily apparent upon further review of the following specification.

### BRIEF DESCRIPTION OF THE DRAWINGS

FIG. 1 is a perspective side view of the chamber of an embodiment of the system according to the present teachings.

FIG. 2 is a perspective top view of the chamber of FIG. 1, with the lid partially removed to show the cavity of the chamber and the magnetic field generating elements.

FIG. 3 is a schematic side view of the chamber of FIG. 1.

FIG. 4 is a graph showing the amount of water and sediment present in three crude oil samples, before and after treatment using the method of the present teachings.

FIG. 5 is a graph showing the percent of water and sediment removed from a first crude oil sample versus magnetite concentration.

FIG. 6 is a graph showing the percent of water and sediment removed from a second crude oil sample versus magnetite concentration.

FIG. 7 is a graph showing the percent of water and sediment removed from a third crude oil sample versus magnetite concentration.

FIG. 8 is a graph showing the percent of water and sediment removed from a first diesel fuel sample versus magnetite concentration.

FIG. 9 is a graph showing the percent of water and sediment removed from a second diesel fuel sample versus magnetite concentration.

FIG. 10 is a graph showing the percent of water and sediment removed from a third diesel fuel sample versus magnetite concentration.

FIG. 11 is a graph showing the percent of water and sediment removed from three cooking oil samples versus magnetite concentration.

Similar reference characters denote corresponding features consistently throughout the attached drawings.

### DETAILED DESCRIPTION OF THE PREFERRED EMBODIMENTS

A method for separating water from oil can include the steps of adding magnetite powder to a mixture of oil and water and directing the resulting oil, water, and magnetite mixture to a magnetic chamber including magnetic field generating elements. The magnetic field generating elements can provide a magnetic field of about 12,000 gauss, for example. As the magnetite powder is hydrophobic, the magnetite powder can coalesce with the oil inside the chamber, such that the oil and magnetite powder are elevated and the water sinks to the bottom of the chamber. A valve at a lower portion of the chamber can be opened to drain the water collected at the bottom of the chamber. After the water is drained, the fluid remaining in the chamber includes magnetite and crude oil.

In an embodiment, the magnetite powder includes magnetite nanoparticles. The nanoparticles can range in size from about 15 nm to about 35 μm, for example from about 15 nm to about 5 μm. In an embodiment, the oil is selected from crude oil, diesel fuel, and cooking oil. Although separation of oil from water is described herein, it should be understood that the present method can be used to separate water from other viscous fluids in a similar manner.

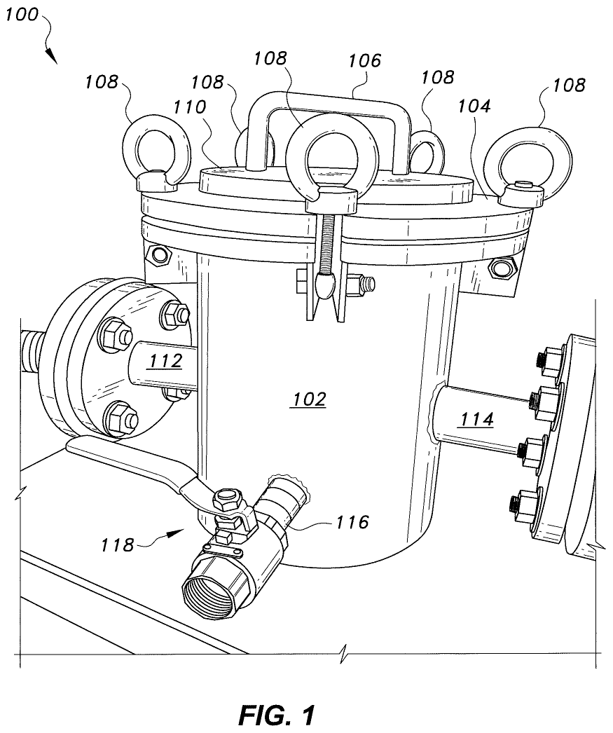

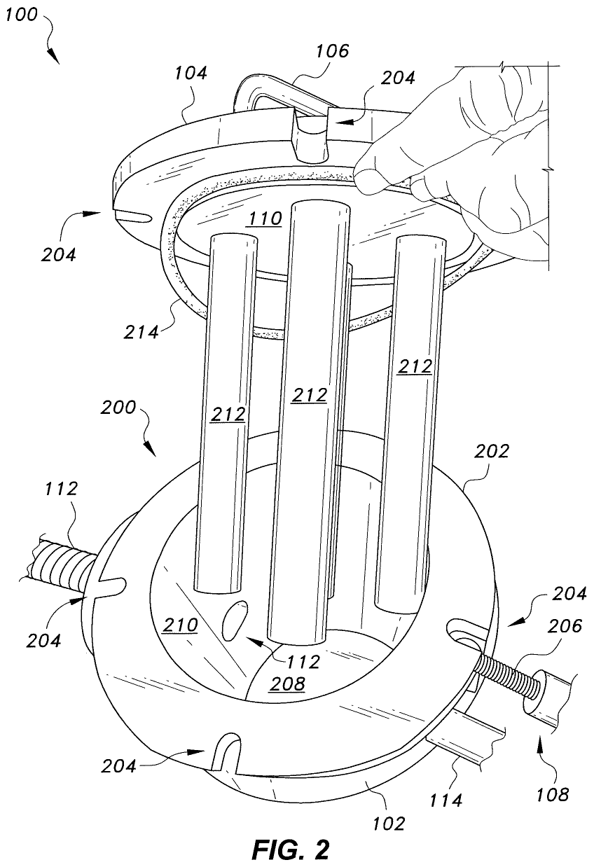

A system 100 for separating water from oil is shown in FIG. 1. The system 100 includes a chamber 102 and a removeable lid 104 for access to the chamber's interior cavity 200, the details of which are shown in FIGS. 1-3. The chamber body 102 includes a bottom wall 208, and an upright cylindrical sidewall 210 extending from the bottom wall 208. An inlet pipe 112, a crude oil outlet pipe 114 and a water outlet pipe 116 extend through the cylindrical sidewall 210. The inlet pipe 112 and the crude oil outlet pipe 114 are at a higher level than the water outlet pipe 116. A water valve 118 is provided in the water outlet pipe 116, to selectively release water from the chamber's cavity 200. A radially extending flange 202 extends outwardly from the top of the cylindrical sidewall 210 and includes latch slots 204 spaced around an outer edge thereof.

The removeable lid 104 includes a centrally located magnetic element support plate 110 with a handle 106 for manipulating the lid 104 attached to a top surface. A plurality of magnetic field generating elements 212 extend downwardly from the bottom surface of the magnetic element support plate 110. The magnetic field generating elements 212 are electrically connected to a power supply (not shown) and produce a magnetic field in the chamber's cavity 200 when activated. The lid 104 can include a plurality of pivoting and tightening latches 108 for securing the lid 104 to the top of the chamber 102. The latches 108 include threaded shafts 206 that extend through the latch slots 204 in the radially extending flange 202, and latch slots 204 in the lid 104, when the latches are in their locked position. An O-ring seal 214 between the lid 104 and the flange 202, seals the chamber's interior 200.

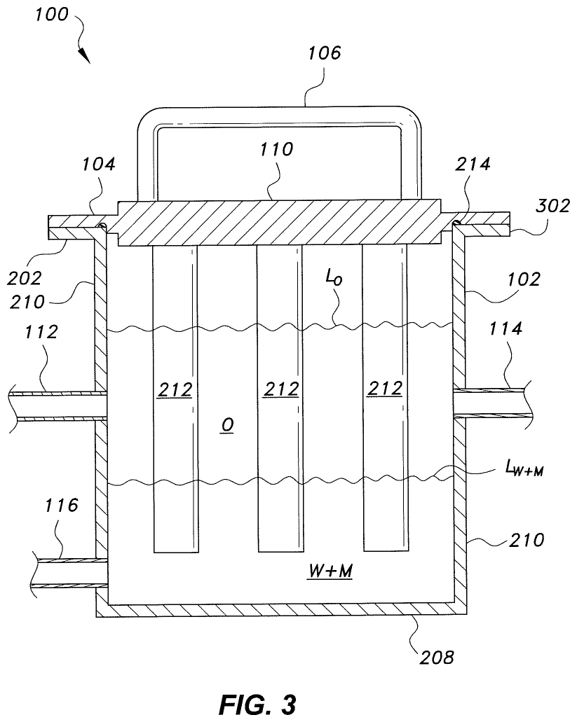

The operation of the system 100 is illustrated in FIG. 3. A mixture of oil, water and magnetite powder can be fed into the chamber via the inlet pipe 112. The magnetic field generating elements 212 can be activated to produce a magnetic field of 12,000 gauss, such that the oil and magnetite powder are separated from the water and the water remains at the bottom of the chamber. Water valve 118 can be opened to release the water at the bottom of the chamber and allow the oil to be lowered to the bottom. Once the oil lowers to a pre-determined level, a sensor provided at a lower portion of the chamber, proximate the water valve 118 detects the crude oil and the valve is closed to prevent the oil from escaping. Closing the valve at an appropriate time can avoid loss of the oil and magnetite combination through the water outlet pipe 116. The oil 0 and magnetite combination exits the chamber body 102 via the crude oil outlet pipe 114.

The efficiency of different sized magnetite particles (powder) sizes for removing crude oil (30° API) (SAE-30), diesel fuel and cooking oil from water was determined using the standard test method for water and sediment in crude oil by the centrifuge method (ASTM D4007—11(2016)e1). Samples with magnetite particles having the following mean particle sizes were tested: 35 μm (Sample A), 5 μm (Sample B), and 15 nm (Sample C)). with a temperature range of 60° C. (+−3). As described herein, Sample A showed a lower removing efficiency compared to both Sample B and Sample C because the surface area of the magnetite particles in this sample was smaller than that of the particles of Sample B and C. Increased surface area of the particles facilitates combining with more oil droplets in the sample. In other words, as particle size is reduced, more oil droplet can be collected from the sample.

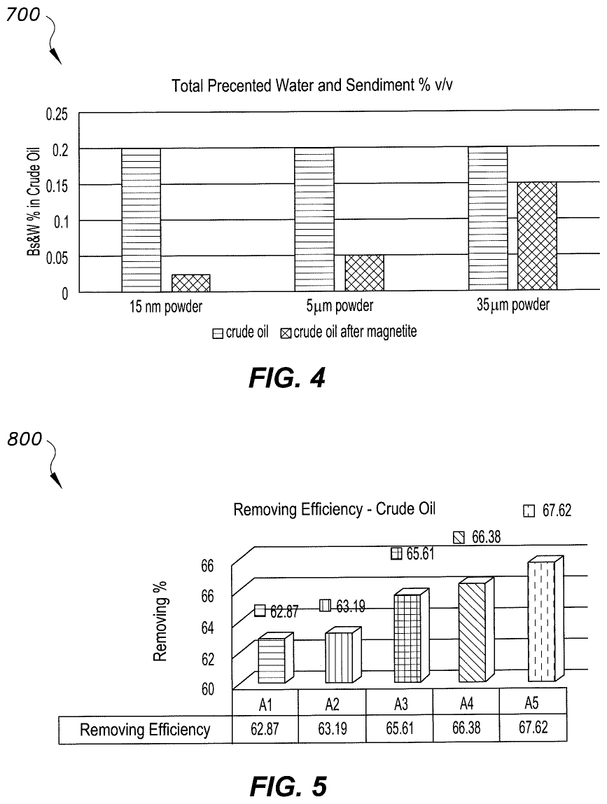

FIG. 4 is a graph 700 showing the amount of Bs&W present in three crude oil samples, before and after treatment using three different mean particle sizes of magnetite (15 nm, 5 μm and 35 μm). As can be seen from the graph 700, the size of the particle has a direct effect on the amount of Bs&W removed from the crude oil. For the 15 nm magnetite particles, the Bs&W was reduced from 0.2% before treatment to 0.025% after treatment. For the 5 μm magnetite particles, the Bs&W was reduced from 0.2% before treatment to 0.05% after treatment. For the 35 μm magnetite particles, the Bs&W was reduced from 0.2% before treatment to 0.15% after treatment. The results of the test for the three different magnetite powders is also outlined in Table 1, below.

TABLE 1

| | | Bs&W | Bs&W | |
|---|---|---|---|---|
| Oil Type | Magnetite Size and Amount | Tube 1 | Tube 2 | Total % |
| Crude oil | N/A | 0.1 | 0.1 | 0.2 |
| Crude oil | 1 g of 15 nm Magnetite | 0.0 | 0.025 | 0.025 |
| Crude oil | 1 g of 5 μm Magnetite | 0.025 | 0.025 | 0.05 |
| Crude oil | 1 g of 35μ Magnetite | 0.075 | 0.075 | 0.15 |

It should be noted that the results were rounded to the closest 0.025% of Bs&W.

FIG. 5 is a graph 800 showing the percent of water and sediment removed from a crude oil sample versus magnetite concentration of 35 μm magnetite powder. The results are also outlined in Table 2 below.

TABLE 2

| Sample | Magnetite | Oil | Size | Empty g | +Oil g | Difference | Eff. |
|---|---|---|---|---|---|---|---|
| A1 | 0.333 g | 2.05 g | 35 μm | 45.5262 | 46.8151 | 1.2889 | 62.87% |
| A2 | 0.4 g | 2.04 g | 35 μm | 43.5112 | 44.8002 | 1.289 | 63.19% |
| A3 | 0.5 g | 2 g | 35 μm | 44.1556 | 45.4678 | 1.3122 | 65.61% |
| A4 | 0.8 g | 2.08 g | 35 μm | 43.2816 | 44.6622 | 1.3806 | 66.38% |
| A5 | 1.0 g | 2.06 g | 35 μm | 44.2803 | 45.6733 | 1.393 | 67.62% |

The graph 800 and Table 2 indicate that as the amount of 35 μm magnetite powder is increased from 0.333 g to 1 g, the efficiency (Eff.) increases steadily from 62.87% to 67.62%.

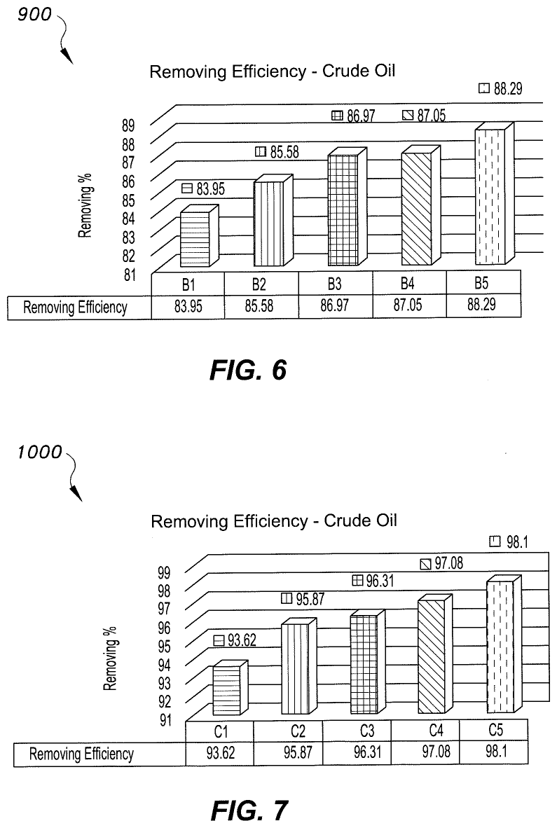

FIG. 6 is a graph 900 showing the percent of water and sediment removed from a crude oil sample versus magnetite concentration of 5 μm magnetite powder. The results are also outlined in Table 3 below.

TABLE 3

| Sample | Magnetite | Oil | Size | Empty g | +Oil g | Difference | Eff. |
|---|---|---|---|---|---|---|---|
| B1 | 0.333 g | 2.03 g | 5μ | 45.2231 | 46.9272 | 1.7041 | 83.95% |
| B2 | 0.4 g | 2.04 g | 5μ | 43.2561 | 45.0019 | 1.7458 | 85.58% |
| B3 | 0.5 g | 2.01 g | 5μ | 43.5863 | 45.3344 | 1.7481 | 86.97% |
| B4 | 0.8 g | 2.01 g | 5μ | 44.2024 | 45.9522 | 1.7498 | 87.05% |
| B5 | 1.0 g | 2.08 g | 5μ | 51.7938 | 53.6303 | 1.8365 | 88.29% |

The results show a slight increase in efficiency of removing the crude oil from the seawater as the amount of 5 μm magnetite is increased. The graph 900 and Table 3 indicate that as the amount of 5 μm magnetite powder is increased from 0.333 g to 1 g, the efficiency (Eff.) increases steadily from 83.95% to 88.29%.

FIG. 7 is a graph 1000 showing the percent of water and sediment removed from a crude oil sample versus magnetite concentration of 15 nm magnetite powder. The results are also outlined in Table 4 below. The surface area of this particle size is greater per volume, than those of the larger particles.

TABLE 4

| Sample | Magnetite | Oil | Size | Empty g | +Oil g | Difference | Eff. |
|---|---|---|---|---|---|---|---|
| C1 | 0.333 g | 2.03 g | 15 nm | 43.8446 | 45.7451 | 1.9005 | 93.62% |
| C2 | 0.4 g | 2.02 g | 15 nm | 43.0763 | 45.0129 | 1.9366 | 95.87% |
| C3 | 0.5 g | 2.02 g | 15 nm | 44.0038 | 45.9492 | 1.9454 | 96.31% |
| C4 | 0.8 g | 2.055 g | 15 nm | 48.0064 | 50.0013 | 1.9949 | 97.08% |
| C5 | 1.0 g | 2.021 g | 15 nm | 46.0024 | 47.9851 | 1.9827 | 98.1% |

The results show a slight increase in efficiency of removing the crude oil from the seawater as the amount of 15 nm magnetite is increased. The graph 1000 and Table 4 indicate that as the amount of 15 nm magnetite powder is increased from 0.333 g to 1 g, the efficiency (Eff.) increases steadily from 93.62% to 98.1%.

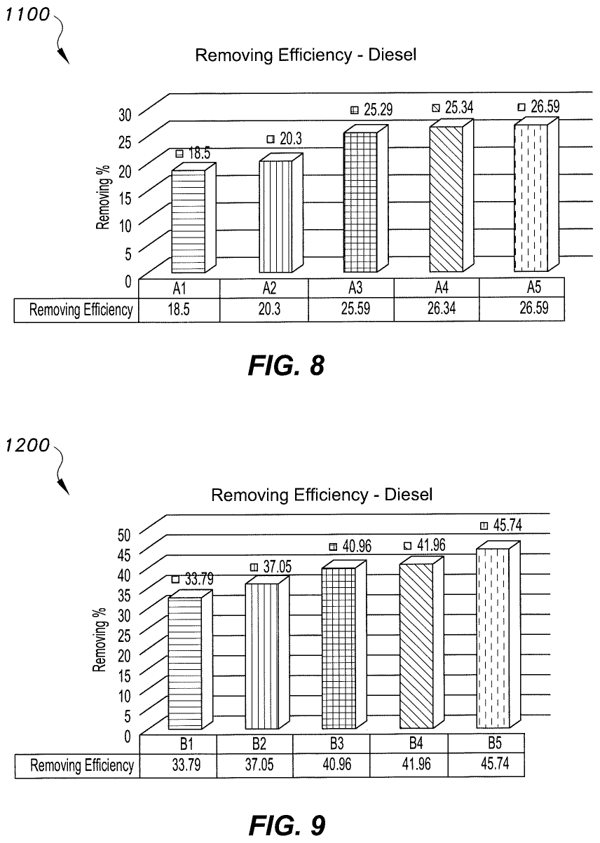

FIG. 8 is a graph 1100 showing the percent of water and sediment removed from a diesel fuel sample versus magnetite concentration of 35 μm magnetite powder. The results are also outlined in Table 5 below.

TABLE 5

| Sample | Magnetite | Diesel | Size | Empty g | +Oil g | Difference | Eff. |
|---|---|---|---|---|---|---|---|
| A1 | 0.333 g | 2.05 g | 35μ | 43.8 | 44.1793 | 0.3793 | 18.5% |
| A2 | 0.4 g | 2.06 g | 35μ | 43.9 | 44.3182 | 0.4182 | 20.3% |
| A3 | 0.5 g | 2.04 g | 35μ | 44.4 | 44.916 | 0.516 | 25.29% |
| A4 | 0.8 g | 2.02 g | 35μ | 48 | 48.5321 | 0.5321 | 26.34% |
| A5 | 1.0 g | 2.05 g | 35μ | 42.7 | 43.245 | 0.545 | 26.59% |

The graph 1100 and Table 5 indicate that as the amount of 35μ magnetite powder is increased from 0.333 g to 1 g, the efficiency (Eff.) increases steadily from 18.5% to 26.59%.

FIG. 9 is a graph 1200 showing the percent of water and sediment removed from a diesel fuel sample versus magnetite concentration of 5 μm magnetite powder. The results are also outlined in Table 6 below.

TABLE 6

| Sample | Magnetite | Diesel | Size | Empty g | +Oil g | Difference | Eff. |
|---|---|---|---|---|---|---|---|
| B1 | 0.333 g | 2.08 g | 5μ | 42.7892 | 43.492 | 0.7028 | 33.79% |
| B2 | 0.4 g | 2.06 g | 5μ | 43.8235 | 44.5867 | 0.7632 | 37.05% |
| B3 | 0.5 g | 2.05 g | 5μ | 43.9771 | 44.8168 | 0.8397 | 40.96% |
| B4 | 0.8 g | 2.03 g | 5μ | 48.067 | 48.9187 | 0.8517 | 41.96% |
| B5 | 1.0 g | 2.05 g | 5μ | 44.447 | 45.3846 | 0.9376 | 45.74% |

The graph 1200 and Table 6 indicate that as the amount of 5 μm magnetite powder is increased from 0.333 g to 1 g, the efficiency (Eff.) increases steadily from 33.79% to 45.74%, substantially higher than the 35 μm magnetite powder efficiency.

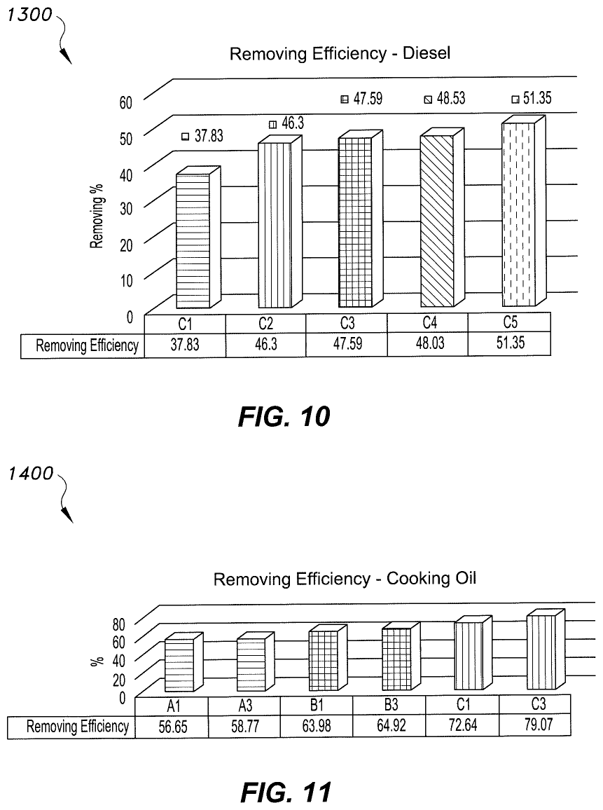

FIG. 10 is a graph 1300 showing the percent of water and sediment removed from a diesel fuel sample versus magnetite concentration of 15 nm magnetite powder. The results are also outlined in Table 7 below.

TABLE 7

| Sample | Magnetite | Diesel | Size | Empty g | +Oil g | Difference | Eff. |
|---|---|---|---|---|---|---|---|
| C1 | 0.333 g | 2 g | 15 nm | 43.2256 | 43.9821 | 0.7565 | 37.83% |
| C2 | 0.4 g | 2.05 g | 15 nm | 45.625 | 46.5742 | 0.9492 | 46.3% |
| C3 | 0.5 g | 2.05 g | 15 nm | 44.093 | 45.0686 | 0.9756 | 47.59% |
| C4 | 0.8 g | 2.02 g | 15 nm | 43.0118 | 43.9821 | 0.9703 | 48.03% |
| C5 | 1.0 g | 2.04 g | 15 nm | 44.1664 | 45.214 | 1.0476 | 51.35% |

The graph 1300 and Table 7 indicate that as the amount of 15 nm magnetite powder is increased from 0.333 g to 1 g, the efficiency (Eff.) increases steadily from 37.83% to 51.35%, Accordingly, the magnetite powder can be used both diesel fuel and crude oil removal from water.

FIG. 11 is a graph 1400 showing the percent of water and sediment removed from three cooking oil samples versus magnetite concentration. The results are also outlined in Table 8 below.

TABLE 8

| Sample | Magnetite | Oil | Size | Empty g | +Oil g | Difference | Eff. |
|---|---|---|---|---|---|---|---|
| A1 | 0.333 g | 2.06 g | 35μ | 45.047 | 46.214 | 1.167 | 56.65% |
| A3 | 0.5 g | 2.05 g | 35μ | 53.679 | 54.8837 | 1.2047 | 58.77% |
| B1 | 0.333 g | 2.03 g | 5μ | 45.426 | 46.7248 | 1.2988 | 63.98% |
| B3 | 0.5 g | 2.08 g | 5μ | 50.371 | 51.7214 | 1.3504 | 64.92% |
| C1 | 0.333 g | 2.03 g | 15 nm | 51.654 | 53.1285 | 1.4745 | 72.64% |
| C3 | 0.5 g | 2.0 g | 15 nm | 52.228 | 53.8095 | 1.5815 | 79.07% |

The graph 1400 and Table 8 indicate that as the amount of 35 μm magnetite powder is increased from 0.333 g to 0.5 g, the efficiency (Eff.) increases only slightly from 56.65% to 58.77%. The efficiency also increases only slightly as the amount of 5 μm magnetite powder is increased from 0.333 g to 0.5 g, from 63.98% to 64.92%. As the amount of 15 nm magnetite powder is increased from 0.333 g to 0.5 g, the efficiency increases substantially when compared to the larger powders, from 72.64% to 79.07%. While the efficiency of the magnetite powder when used with cooking oil is less than its efficiency when used with crude oil, it is substantially more efficient at removing/recovering cooking oil when compared with diesel fuel.

It is to be understood that the method of and system for separating water from oil is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method for separating water from oil, comprising the steps of:
adding magnetite powder to a mixture of the oil and the water; and
subjecting the mixture to a magnetic field, such that the magnetite powder and the oil are drawn out of the mixture, wherein as a result of the subjecting, the water is separated from the oil such that a quality of the oil is increased and wherein the increased quality of the oil is a measurement of a reduced amount of water and sediment (Bs&W) content of the oil.

2. The method as recited in claim 1, wherein the magnetite powder comprises magnetite particles having a mean particle size ranging from 15 nm to about 35 μm.

3. The method as recited in claim 2, wherein the magnetite powder comprises magnetite particles having a mean particle size ranging from 15 nm to about 5 μm.

4. The method as recited in claim 1, wherein the oil is crude oil.

5. The method as recited in claim 1, wherein the oil is diesel fuel.

6. The method as recited in claim 1, wherein the oil is cooking oil.

7. The method as recited in claim 1, wherein the magnetite powder comprises magnetite particles having a mean particle size of about 15 nm.

8. A system for separating water from oil, comprising:
a chamber body including a bottom, an upright cylinder sidewall extending from the bottom, and a chamber cavity;
an inlet pipe extending through one side of the cylindrical sidewall to the chamber cavity;
a crude oil outlet pipe extending through an opposing side of the cylindrical sidewall to the chamber cavity;
a water outlet pipe extending through the cylindrical sidewall to the chamber cavity, the inlet pipe and the crude oil pipe being at a higher level than the water outlet pipe; and
a removable lid for closing a top of the chamber cavity, the removable lid including a centrally located magnetic element support plate with a top and bottom surface; and
a plurality of magnetic field generating elements extending downwardly from the bottom surface of the magnetic element support plate, wherein said plurality of magnetic field elements generate a magnetic field wherein as a result of said magnetic field, the water is separated from the oil such that a quality of the oil is increased and wherein the increased quality of the oil is a measurement of a reduced amount of water and sediment (Bs&W) content of the oil.

9. The system as recited in claim 8, further comprising a water valve in the water outlet pipe.

10. The system as recited in claim 9, further comprising a handle attached to the top surface of the magnetic element support plate.

11. A method for separating water from oil using the system of claim 8, comprising the steps of:
directing a mixture of oil, water, and magnetite powder into the chamber body through the inlet pipe;
activating the magnetic field generating elements to produce a magnetic field for separating the oil and magnetite powder from the water in the chamber body wherein as a result of the activating, the water is separated from the oil such that a quality of the oil is increased and wherein the increased quality of the oil is a measurement of a reduced amount of water and sediment (Bs&W) content of the oil; and
opening the water valve to release the water separated from the magnetite powder and oil.
